(19) United States
(12) Patent Application Publication
(10) Pub. No.: US 2025/0238163 A1
(43) Pub. Date: Jul. 24, 2025

(54) STORING DATA IN A HOST MEMORY BUFFER

(71) Applicant: Micron Technology, Inc., Boise, ID (US)

(72) Inventor: Cory M. Steinmetz, Boise, ID (US)

(21) Appl. No.: 19/029,590

(22) Filed: Jan. 17, 2025

Related U.S. Application Data
(60) Provisional application No. 63/623,502, filed on Jan. 22, 2024.

(51) Int. Cl. G06F 3/06

(52) U.S. Cl. CPC G06F 3/0656; G06F 3/0605; G06F 3/0659; G06F 3/0683

(57) ABSTRACT

The disclosure configures a memory sub-system controller to store data in a host memory buffer. The controller accesses data that identifies a host memory buffer (HMB) portion of a temporary storage device that has been allocated to a memory sub-system by a host. The controller generates a virtual address space associated with the memory sub-system, the virtual address space comprising a first set of physical storage locations on one or more storage devices of the memory sub-system and a second set of physical storage locations on the HMB. The controller performs one or more memory operations on user data received from the host using the virtual address space and a set of memory components of the memory sub-system.

### PRIORITY APPLICATION

This application claims the benefit of priority to U.S. Provisional Application Ser. No. 63/623,502, filed Jan. 22, 2024, which is incorporated herein by reference in its entirety.

### TECHNICAL FIELD

Examples of the disclosure relate generally to memory sub-systems and, more specifically, to providing adaptive media management for memory components, such as memory dies.

### BACKGROUND

A memory sub-system can be a storage system, such as a solid-state drive (SSD), and can include one or more memory components that store data. The memory components can be, for example, non-volatile memory components and volatile memory components. In general, a host system can utilize a memory sub-system to store data on the memory components and to retrieve data from the memory components.

### BRIEF DESCRIPTION OF THE DRAWINGS

The present disclosure will be understood more fully from the detailed description given below and from the accompanying drawings of various examples of the disclosure.

FIG. 1 is a block diagram illustrating an example computing environment including a memory sub-system, in accordance with some examples.

FIG. 2 is a block diagram of an example media operations manager, in accordance with some examples.

FIG. 3 is a block diagram of an example virtual address space of the memory sub-system, in accordance with some examples.

FIG. 4 is a flow diagram of an example method to perform memory operations using a virtual address space of a memory sub-system, in accordance with some examples.

FIG. 5 is a block diagram illustrating a diagrammatic representation of a machine in the form of a computer system within which a set of instructions can be executed for causing the machine to perform any one or more of the methodologies discussed herein, in accordance with some examples.

### DETAILED DESCRIPTION

Examples of the present disclosure configure a system component, such as a memory sub-system controller (and/or host), to dynamically store and/or cache user data on a local storage device and/or a temporary storage device (e.g., a DRAM) of a host. Specifically, the disclosed techniques can access data that identifies a host memory buffer (HMB) portion of the temporary storage device that has been allocated to the memory sub-system by a host. The disclosed techniques generate a virtual address space associated with the memory sub-system. The virtual address space can include a first set of physical storage locations on one or more storage devices of the memory sub-system and a second set of physical storage locations on the HMB. The disclosed techniques perform one or more memory operations on user data received from the host using the virtual address space and a set of memory components of the memory sub-system. By utilizing storage available locally on the local storage device and storage allocated by the host on the HMB, a greater amount of temporary storage becomes available for performing memory operations which can reduce access times and improves the overall efficiencies of the memory sub-system.

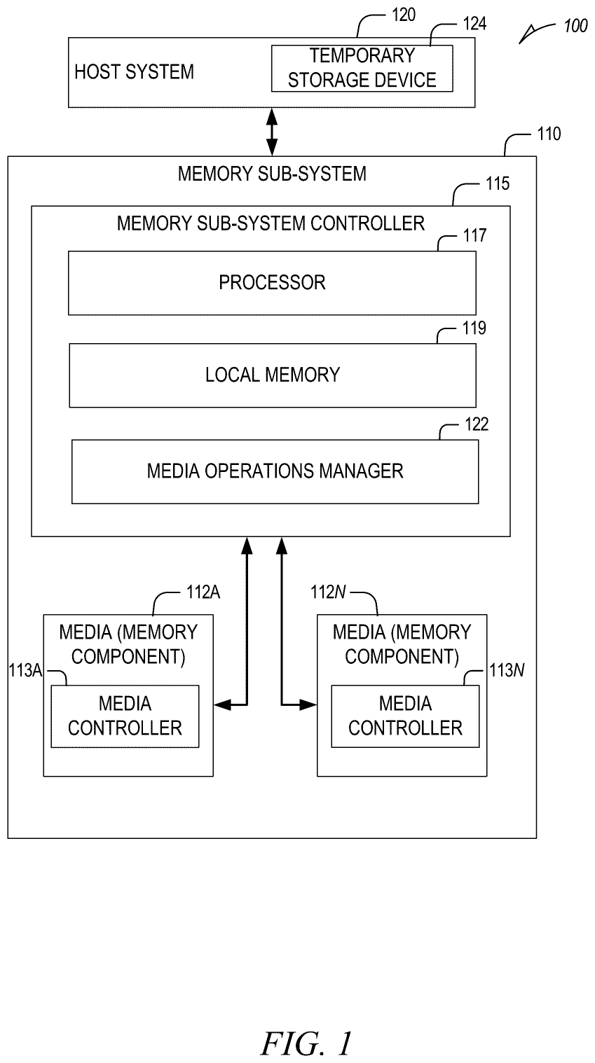

A memory sub-system can be a storage device, a memory module, or a hybrid of a storage device and memory module. Examples of storage devices and memory modules are described below in conjunction with FIG. 1. In general, a host system can utilize a memory sub-system that includes one or more memory components, such as memory devices (e.g., memory dies or planes across multiple memory dies) that store data. The host system can send access requests (e.g., write command, read command) to the memory sub-system, such as to store data at the memory sub-system and to read data from the memory sub-system. The data (or set of data) specified by the host is hereinafter referred to as “host data,” “application data,” or “user data.”

The memory sub-system can initiate media management operations (also referred to as backend operations), such as a write operation, on host data that is stored on a memory device. For example, firmware of the memory sub-system may re-write previously written host data from a location on a memory device to a new location as part of garbage collection management operations. The data that is re-written, for example as initiated by the firmware, is hereinafter referred to as “garbage collection data.” “User data” can include host data and garbage collection data. “System data” hereinafter refers to data that is created and/or maintained by the memory sub-system for performing operations in response to host requests and for media management. Examples of system data include, and are not limited to, system tables (e.g., logical-to-physical address mapping table), data from logging, scratch pad data, etc.

Many different media management operations can be performed on the memory device. For example, the media management operations can include different scan rates, different scan frequencies, different wear leveling, different read disturb management, different near miss error correction (ECC), and/or different dynamic data refresh. Wear leveling ensures that all blocks in a memory component approach their defined erase-cycle budget at the same time, rather than some blocks approaching it earlier. Read disturb management counts all of the read operations to the memory component. If a certain threshold is reached, the surrounding regions are refreshed. Near-miss ECC refreshes all data read by the application that exceeds a configured threshold of errors. Dynamic data-refresh scan reads all data and identifies the error status of all blocks as a background operation. If a certain threshold of errors per block or ECC unit is exceeded in this scan-read, a refresh operation is triggered.

A memory device can be a non-volatile memory device. A non-volatile memory device is a package of one or more dice (or dies). Each die can be comprised of one or more planes. For some types of non-volatile memory devices (e.g., NAND devices), each plane is comprised of a set of physical blocks. For some memory devices, blocks are the smallest area than can be erased. Such blocks can be referred to or addressed as logical units (LUN). Each block is comprised of a set of pages. Each page is comprised of a set of memory cells, which store bits of data. The memory devices can be raw memory devices (e.g., NAND), which are managed externally, for example, by an external controller. The memory devices can be managed memory devices (e.g., managed NAND), which is a raw memory device combined with a local embedded controller for memory management within the same memory device package.

Some SSDs (e.g., memory sub-systems) that exclude a DRAM are referred to as DRAM-less SSDs. In such systems, configuration data and various other system information, such as logical to physical address maps/tables, are stored on a specified portion of a DRAM of a host. This specified portion is usually referred to as the HMB. Memory sub-systems that include local temporary storage devices (e.g., DRAM or SRAM) (referred to as DRAM-enabled SSDs) have no need for the HMB. Such systems store the configuration information and various other system information locally on the DRAM or the SRAM. Because the DRAM-enabled SSDs do not utilize the HMB, such storage resources are wasted.

Examples of the present disclosure address the above and other deficiencies by providing a memory controller that can leverage the HMB for performing memory operations on a DRAM-enabled SSD. Specifically, the memory controller can dynamically control whether data (e.g., configuration data and/or user data) is stored locally on the local storage device(s) (e.g., the DRAM/SRAM not the NAND or non-volatile memory devices) of the memory sub-system and/or on the HMB (e.g., the temporary storage device of the host). To do so, the memory controller can generate a virtual address space that includes physical storage locations of the local storage device(s) of the memory sub-system and the HMB. The memory controller can then utilize the virtual address space to store the data on either or both the physical storage locations of the local storage device(s) of the memory sub-system and/or the HMB. This increases the overall amount of storage resources available to the memory sub-system which increases the overall efficiency of the device.

Specifically, the disclosed techniques access data that identifies a HMB portion of a temporary storage device that has been allocated to the memory sub-system by a host. The disclosed techniques generate a virtual address space associated with the memory sub-system, the virtual address space including a first set of physical storage locations on the one or more storage devices and a second set of physical storage locations on the HMB. The disclosed techniques perform one or more memory operations on user data received from the host using the virtual address space and the set of memory components.

In some cases, the one or more storage devices include at least one static random access memory (SRAM) device or a first dynamic random access memory (DRAM) device and the set of memory components includes non-volatile memory devices. The temporary storage device can include a second DRAM device and the non-volatile memory devices can include NAND storage devices.

The disclosed techniques store the user data received from the host on the HMB. In some examples, the disclosed techniques receive, from the host, a request to program the user data and store, on a first portion of the first set of physical storage locations, a mapping between a set of logical addresses associated with the request and a set of physical addresses on the set of memory components. The disclosed techniques cache, on a second portion of the first set of physical storage locations, the user data prior to programming the user data to the set of physical addresses on the set of memory components. The disclosed techniques cache, on a portion of the second set of physical storage locations on the HMB, the user data that is also cached on the second portion of the first set of physical storage locations.

In some examples, the disclosed techniques transmit, by the at least one processing device, an instruction to the temporary storage device to store the user data on the second set of physical storage locations on the HMB. The disclosed techniques delete the user data from the second portion of the first set of physical storage locations after programming the user data to the set of physical addresses on the set of memory components and maintain (retain or prevent deletion of) storage of the user data on the second set of physical storage locations on the HMB after programming the user data to the set of physical addresses on the set of memory components.

The disclosed techniques receive a read request from the host associated with the set of logical addresses and determine that the set of logical addresses corresponds to the user data that has been cached on the portion of the second set of physical storage locations on the HMB. The disclosed techniques retrieve the user data from the portion of the second set of physical storage locations on the HMB in response to receiving the read request from the host. In some cases, the disclosed techniques transmit, to the host, the user data that has been retrieved by the at least one processing device from the portion of the second set of physical storage locations on the HMB.

In some examples, the disclosed techniques receive, from the host, a request to read the user data from a set of logical addresses. The disclosed techniques search, the first set of physical storage locations, to identify a set of physical addresses on the set of memory components mapped to the set of logical addresses. The disclosed techniques retrieve, from the set of memory components, the user data stored in the set of physical addresses and cache, on a portion of the second set of physical storage locations on the HMB, the user data that has been retrieved from the set of memory components. The disclosed techniques receive, from the host, an additional request to read the user data from the set of logical addresses and determine that the set of logical addresses corresponds to the user data that has been cached on the portion of the second set of physical storage locations on the HMB. In such instances, the disclosed techniques retrieve the user data from the portion of the second set of physical storage locations on the HMB in response to receiving the additional read request from the host instead of retrieving the user data from the set of memory components.

The disclosed techniques can predict a set of physical addresses on the set of memory components that is likely to be read by the host and retrieve, from the set of memory components, a set of user data stored in the set of physical addresses. The disclosed techniques cache, on a portion of the second set of physical storage locations on the HMB, the set of user data that has been retrieved from the set of physical addresses that is predicted to be read by the host. The disclosed techniques prioritize storage of a logical to physical address mapping on the first set of physical storage locations on one or more storage devices of the memory sub-system. In some cases, the disclosed techniques determine that the one or more storage devices of the memory sub-system are full. The disclosed techniques, in response to determining that the one or more storage devices of the memory sub-system are full, program additional memory management data on the second set of physical storage locations on the HMB instead of the one or more storage devices of the memory sub-system.

Though various examples are described herein as being implemented with respect to a memory sub-system (e.g., a controller of the memory sub-system), some or all of the portions of an example can be implemented with respect to a host system, such as a software application or an operating system of the host system.

FIG. 1 illustrates an example computing environment 100 including a memory sub-system 110, in accordance with some examples of the present disclosure. The memory sub-system 110 can include media, such as memory components 112A to 112N (also hereinafter referred to as “memory devices”). The memory components 112A to 112N can be volatile memory devices, non-volatile memory devices, or a combination of such. The memory components 112A to 112N can be implemented by individual dies, such that a first memory component 112A can be implemented by a first memory die (or a first collection of memory dies) and a second memory component 112N can be implemented by a second memory die (or a second collection of memory dies). Each memory die can include a plurality of planes in which data can be stored or programmed. In some cases, the first memory component 112A can be implemented by a first SSD (or a first independently operable memory sub-system) and the second memory component 112N can be implemented by a second SSD (or a second independently operable memory sub-system).

In some examples, the memory sub-system 110 is a storage system. A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and a non-volatile dual in-line memory module (NVDIMM).

The computing environment 100 can include a host system 120 that is coupled to a memory system. The memory system can include one or more memory sub-systems 110. In some examples, the host system 120 is coupled to different types of memory sub-system 110. FIG. 1 illustrates one example of a host system 120 coupled to one memory sub-system 110. The host system 120 uses the memory sub-system 110, for example, to write data to the memory sub-system 110 and read data from the memory sub-system 110. As used herein, “coupled to” generally refers to a connection between components, which can be an indirect communicative connection or direct communicative connection (e.g., without intervening components), whether wired or wireless, including connections such as electrical, optical, magnetic, etc.

The host system 120 can be a computing device such as a desktop computer, laptop computer, network server, mobile device, embedded computer (e.g., one included in a vehicle, industrial equipment, or a networked commercial device), or such computing device that includes a memory and a processing device. The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL), a universal serial bus (USB) interface, a Fibre Channel interface, a Serial Attached SCSI (SAS) interface, etc. The physical host interface can be used to transmit data between the host system 120 and the memory sub-system 110. The host system 120 can further utilize an NVM Express (NVMe) interface to access the memory components 112A to 112N when the memory sub-system 110 is coupled with the host system 120 by the PCIe or CXL interface. The physical host interface can provide an interface for passing control, address, data, and other signals between the memory sub-system 110 and the host system 120.

The host system 120 can include a temporary storage device 124. The temporary storage device 124 can be a volatile storage device, such as DRAM and/or SRAM. The host system 120 can allocate a certain portion of the temporary storage device 124 as a HMB. This certain portion can be used by the memory sub-system 110 to perform various operations and/or to cache user data of the memory sub-system 110. The host system 120 can provide data to the memory sub-system 110 that identifies this certain portion of the temporary storage device 124 that has been allocated for use as the HMB. The data can identify the certain portion by a physical address range. This portion of the temporary storage device 124 can remain unused by the host system 120 during operations. Namely, the portion of the temporary storage device 124 that is allocated to the memory sub-system 110 is exclusively used by the memory sub-system 110 and is not allocated to the operating system of the host system 120 as available memory. The memory sub-system 110 can store the identification of the physical address range that has been allocated by the host system 120 as part of the configuration information. Using this physical address range, the processor 117 can generate a virtual address range that includes the HMB and that also includes physical portions of the local memory 119 (e.g., local volatile and/or non-volatile storage, such as DRAM and/or SRAM).

The memory components 112A to 112N (which are used to implement the storage capabilities of the memory sub-system 110) can include any combination of the different types of non-volatile memory components and/or volatile memory components and/or storage devices. An example of non-volatile memory components includes a negative-and (NAND)-type flash memory. Each of the memory components 112A to 112N can include one or more arrays of memory cells such as single-level cells (SLCs) or multi-level cells (MLCs) (e.g., TLCs or QLCs). In some examples, a particular memory component 112 can include both an SLC portion and an MLC portion of memory cells. Each of the memory cells can store one or more bits of data (e.g., blocks) used by the host system 120. Although non-volatile memory components such as NAND-type flash memory are described, the memory components 112A to 112N can be based on any other type of memory, such as a volatile memory. In some examples, the memory components 112A to 112N can be, but are not limited to, random access memory (RAM), read-only memory (ROM), dynamic random access memory (DRAM), synchronous dynamic random access memory (SDRAM), phase change memory (PCM), magnetoresistive random access memory (MRAM), negative-or (NOR) flash memory, electrically erasable programmable read-only memory (EEPROM), and a cross-point array of non-volatile memory cells.

A cross-point array of non-volatile memory cells can perform bit storage based on a change of bulk resistance, in conjunction with a stackable cross-gridded data access array. Additionally, in contrast to many flash-based memories, cross-point non-volatile memory can perform a write-in-place operation, where a non-volatile memory cell can be programmed without the non-volatile memory cell being previously erased. Furthermore, the memory cells of the memory components 112A to 112N can be grouped as memory pages or blocks that can refer to a unit of the memory component 112 used to store data. For example, a single first row that spans a first set of the pages or blocks of the memory components 112A to 112N can correspond to or be grouped as a first block stripe and a single second row that spans a second set of the pages or blocks of the memory components 112A to 112N can correspond to or be grouped as a second block stripe.

The memory sub-system controller 115 can communicate with the memory components 112A to 112N to perform memory operations such as reading data, writing data, or erasing data at the memory components 112A to 112N and other such operations. The memory sub-system controller 115 can communicate with the memory components 112A to 112N to perform various memory management operations (also referred to as back-end operations), such as different scan rates, different scan frequencies, different wear leveling, different read disturb management, garbage collection operations, different near miss ECC operations, and/or different dynamic data refresh. In some cases, the memory sub-system controller 115 can utilize the virtual address range to selectively and/or dynamically control whether system data and/or user data is stored on the local memory 119 of the memory sub-system 110 and/or the temporary storage device 124 of the host system 120.

The memory sub-system controller 115 can include hardware, such as one or more integrated circuits and/or discrete components, a buffer memory, or a combination thereof. The memory sub-system controller 115 can be a microcontroller, special-purpose logic circuitry (e.g., a field programmable gate array (FPGA), an application-specific integrated circuit (ASIC), etc.), or another suitable processor. The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120. In some examples, the local memory 119 can include memory registers storing memory pointers, fetched data, and so forth. The local memory 119 can also include read-only memory (ROM) for storing microcode. While the example memory sub-system 110 in FIG. 1 has been illustrated as including the memory sub-system controller 115, in another example of the present disclosure, a memory sub-system 110 may not include a memory sub-system controller 115, and can instead rely upon external control (e.g., provided by an external host, or by a processor 117 or controller separate from the memory sub-system 110).

The local memory 119 can include one or more volatile and/or non-volatile memory devices. For example, the local memory 119 can include a DRAM storage device and/or an SRAM storage device. The local memory 119 can store configuration data for the memory sub-system controller 115 and can store a logical to physical address map or table. In some cases, the local memory 119 can be used by the memory sub-system controller 115 as a cache for data that is going to be programmed to the set of memory components 112A to 112N. Specifically, a request can be received from the host system 120 to program a set of data. In response, the memory sub-system controller 115 can update a logical-to-physical address association in the logical-to-physical address map or table stored in the local memory 119. The memory sub-system controller 115 can also store the set of data in a cache of the local memory 119. At some later point in time, the memory sub-system controller 115 can transfer the set of data from the cache of the local memory 119 to one or more physical locations of the set of memory components 112A to 112N. In some cases, the memory sub-system controller 115 can use the virtual address space to also store or cache the set of data to the HMB of the temporary storage device 124. In such cases, the set of data can be cached in two places at the same time (e.g., on the local memory 119 and on the HMB of the temporary storage device 124). After the data is stored or programmed to the set of memory components 112A to 112N, the memory sub-system controller 115 can delete or remove the data from the cache of the local memory 119 but retain or prevent deletion of that same data from the HMB of the temporary storage device 124. This can enable faster retrieval of the data if the data is subsequently requested to be retrieved or read by the host system 120 as such data can be read from the temporary storage device 124 without accessing the set of memory components 112A to 112N.

In general, the memory sub-system controller 115 can receive commands or operations from the host system 120 and can convert the commands or operations into instructions or appropriate commands to achieve the desired access to the memory components 112A to 112N. In some examples, the commands or operations received from the host system 120 can specify configuration data for the memory components 112N to 112N. The configuration data can describe the lifetime (maximum) PEC values and/or reliability grades associated with different groups of the memory components 112N to 112N and/or different blocks within each of the memory components 112N to 112N of each memory component used to implement the memory sub-system. For example, the memory sub-system may be made up of three memory components (e.g., three SSDs).

The memory sub-system controller 115 can be responsible for other memory management operations, such as wear leveling operations, garbage collection operations, error detection and error-correcting code (ECC) operations, encryption operations, caching operations, and address translations. The memory sub-system controller 115 can further include host interface circuitry to communicate with the host system 120 via the physical host interface. The host interface circuitry can convert the commands received from the host system 120 into command instructions to access the memory components 112A to 112N as well as convert responses associated with the memory components 112A to 112N into information for the host system 120.

The memory sub-system 110 can also include additional circuitry or components that are not illustrated. In some examples, the memory sub-system 110 can include a cache or buffer (e.g., DRAM or other temporary storage location or device) and address circuitry (e.g., a row decoder and a column decoder) that can receive an address from the memory sub-system controller 115 and decode the address to access the memory components 112A to 112N. This cache or buffer can be part of the local memory 119 (as mentioned above) or can be a wholly and entirely or partially separate physical component.

The memory devices can be raw memory devices (e.g., NAND), which are managed externally, for example, by an external controller (e.g., memory sub-system controller 115). The memory devices can be managed memory devices (e.g., managed NAND), which is a raw memory device combined with a local embedded controller (e.g., local media controllers) for memory management within the same memory device package. Any one of the memory components 112A to 112N can include a media controller (e.g., media controller 113A and media controller 113N) to manage the memory cells of the memory component (e.g., to perform one or more memory management operations), to communicate with the memory sub-system controller 115, and to execute memory requests (e.g., read or write) received from the memory sub-system controller 115.

Depending on the example, the media operations manager 122 can comprise logic (e.g., a set of transitory or non-transitory machine instructions, such as firmware) or one or more components that causes the media operations manager 122 to perform operations described herein. The media operations manager 122 can comprise a tangible or non-tangible unit capable of performing operations described herein.

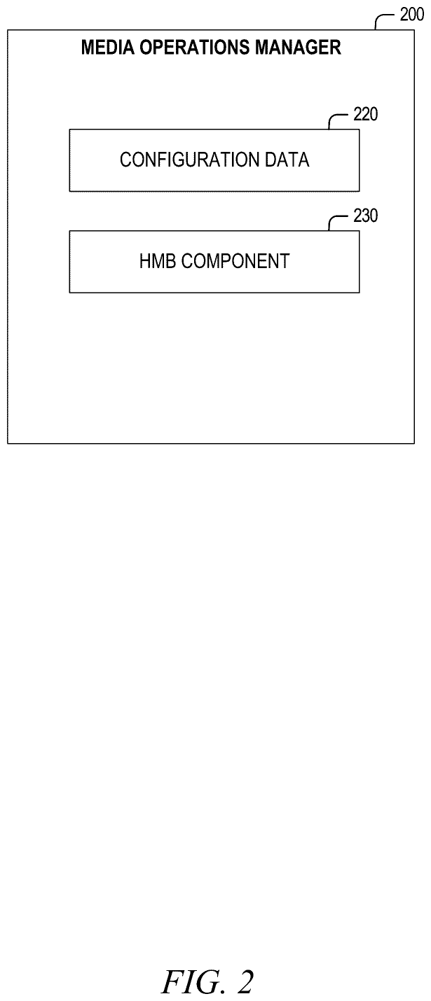

FIG. 2 is a block diagram of an example media operations manager 200 (corresponding to media operations manager 122), in accordance with some implementations of the present disclosure. As illustrated, the media operations manager 200 includes configuration data 220 and a HMB component 230. For some examples, the media operations manager 200 can differ in components or arrangement (e.g., less or more components) from what is illustrated in FIG. 2.

The configuration data 220 accesses and/or stores configuration data associated with the memory components 112A to 112N and with the HMB (e.g., the temporary storage device 124). In some examples, the configuration data 220 is programmed into the media operations manager 200. For example, the media operations manager 200 can communicate with the memory components 112A to 112N to obtain the configuration data and store the configuration data 220 locally on the media operations manager 122.

In some examples, the media operations manager 122 communicates with the host system 120. The host system 120 receives input from an operator or user that specifies parameters including lifetime (maximum) PEC values of different bins, groups, blocks, block stripes, memory dies, and/or sets of the memory components 112A to 112N. The media operations manager 122 can receive configuration data from the host system 120 and stores the configuration data in the configuration data 220. In some cases, the media operations manager 200 receives data from the host system 120 that identifies the physical address range of the HMB. The media operations manager 200 can store the physical address range of the HMB received from the host system 120 as part of the configuration data 220.

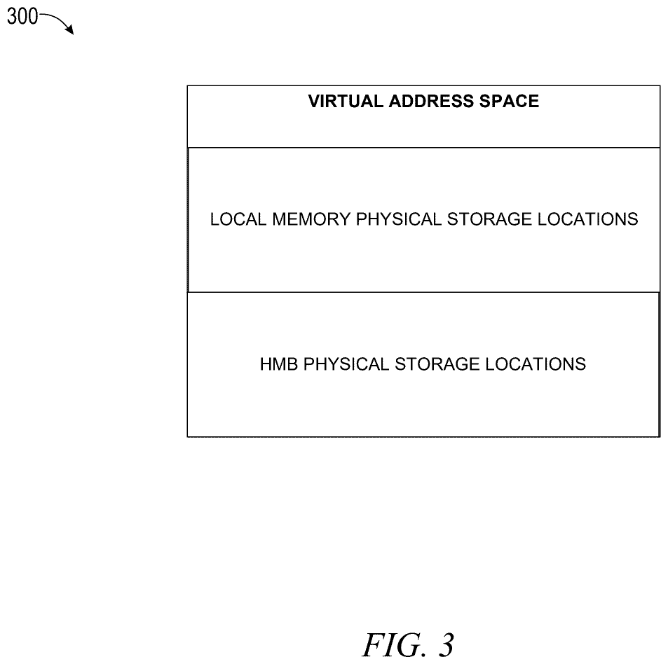

The HMB component 230 can access the HMB information stored in the configuration data 220 to generate a virtual address space for the memory sub-system 110. For example, as shown in FIG. 3, the HMB component 230 can generate a virtual address space 300 that includes local memory physical storage locations (e.g., a set of physical storage locations on the DRAM and/or SRAM of the local memory 119) and the HMB physical storage locations (e.g., including the physical address range of the HMB received from the host system 120). The HMB component 230 can use the virtual address space 300 to selectively and dynamically control whether system data and/or user data is stored locally on the local memory 119 and/or remotely on the HMB.

For example, the HMB component 230 can receive, from the host system 120, a request to program a user data. In response, the HMB component 230 update a mapping of the logical-to-physical address stored on the local memory 119. Namely, the HMB component 230 can identify a set of logical addresses specified in the request and can identify or select a set of corresponding physical addresses on the set of memory components 112A to 112N. The HMB component 230 can then update the logical-to-physical address map stored on the local memory 119 to associate the set of logical addresses with the set of corresponding physical addresses. The HMB component 230 can then cache, on a portion of the local memory 119 (e.g., on the DRAM and/or SRAM), the user data prior to programming the user data to the set of physical addresses on the set of memory components 112A to 112N. In addition, the HMB component 230 can cache, on a portion of the HMB, the user data that is also cached on the portion of the local memory 119. In this way, the user data is cached in two places at the same time (e.g., locally on the local memory 119 and remotely on the temporary storage device 124).

In order to cache the user data on the HMB, the HMB component 230 can transmit an instruction to the temporary storage device 124 to store the user data on a specified set of physical address locations on the HMB. The HMB component 230 can update a mapping stored on the local memory 119 to associate the set of logical addresses with the set of physical addresses of the set of memory components 112A to 112N and also with the set of physical addresses on the HMB where the user data is being stored. After the user data is programmed to the set of memory components 112A to 112N, the HMB component 230 can clear the local cache by deleting the user data from the local memory 119. The HMB component 230 can retain and/or maintain (retain or prevent deletion of) storage of the user data on the HMB after programming the user data to the set of physical addresses on the set of memory components 112A to 112N.

In some examples, the HMB component 230 can receive a read request from the host system 120. The read request can be associated with the set of logical addresses stored in the local memory 119. The HMB component 230 can access the logical-to-physical address map stored in the local memory 119 to determine whether the set of logical addresses is associated with user data that has been cached in the HMB. For example, the HMB component 230 determines that the set of logical addresses corresponds to the user data that has been cached on the portion of the physical storage locations of the temporary storage device 124 (e.g., the HMB). In such cases, the HMB component 230 retrieves the user data from the HMB (e.g., from the physical address locations associated with the set of logical addresses stored in the map or table) in response to receiving the read request from the host system 120. Namely, the HMB component 230 transmits a read request to the temporary storage device 124 to retrieve the user data stored in the corresponding physical address locations. Once that user data is received from the temporary storage device 124 by the memory sub-system controller 115, the memory sub-system controller 115 provides the retrieved data to the host system 120 in response to the read request.

In some examples, the HMB component 230 determines that the set of logical addresses specified in the read request matches a set of physical addresses of the set of memory components 112A to 112N and is not associated with physical addresses of the HMB. In such cases, the HMB component 230 retrieves the user data from the set of memory components 112A to 112N in response to receiving the read request from the host system 120. Once that user data is retrieved from the set of memory components 112A to 112N, the memory sub-system controller 115 provides the retrieved data to the host system 120 in response to the read request.

In some cases, the user data is retained on the temporary storage device 124 until space is needed at which point the user data is replaced in the temporary storage device 124 with other user data or system data of the memory sub-system 110. When the user data is deleted, the mapping stored in the local memory 119 is updated to remove the association, for the user data, between the set of logical addresses and the set of physical addresses of the HMB.

In some examples, the HMB component 230 receives, from the host system 120, a request to read an additional set of user data from an additional set of logical addresses. The HMB component 230 searches the map stored in the local memory 119 to identify an additional set of physical addresses mapped to the additional set of logical addresses. The HMB component 230 retrieves the additional user data stored in the set of memory components 112A to 112N (e.g., if the data is not cached on the HMB). The HMB component 230 can then cache, on a portion of the HMB, the additional user data that has been retrieved from the set of memory components 112A to 112N. This allows the HMB component 230 to subsequently retrieve the additional data from the HMB instead of the set of memory components 112A to 112N when a request to read the same additional set of logical addresses is subsequently received. Namely, the HMB component 230 can retain recently read user data (e.g., recently read logical addresses) on the cache (e.g., on the HMB) for a threshold period of time in order to satisfy subsequent read requests for the same logical addresses faster and more efficiently.

In some cases, rather than waiting for a set of logical addresses to be ready by the host system 120 before caching the corresponding data in the HMB, the HMB component 230 can predict a set of physical addresses on the set of memory components 112A to 112N that is likely to be read by the host system 120. The HMB component 230 can automatically and proactively retrieve, from the set of memory components 112A to 112N, a set of user data stored in the set of physical addresses that are predicted to be read by the host system 120. The HMB component 230 can then cache, on a portion of the HMB, the set of user data that has been retrieved from the set of physical addresses based on the prediction that the physical addresses (or logical addresses) will be read by the host system 120. This allows the HMB component 230 to subsequently retrieve the data (corresponding to the predicted addresses) from the HMB instead of the set of memory components 112A to 112N when a request to read the predicted set of logical addresses is received which improves the performance of the memory sub-system.

In some examples, the HMB component 230 prioritizes storage of a logical-to-physical address mapping on the local memory 119 (e.g., on the local DRAM or SRAM of the memory sub-system 110). In some cases, the HMB component 230 can store at least a portion of the logical-to-physical address mapping on the HMB. In some cases, the HMB component 230 can determine that local memory 119 is full or has stored an amount of data that transgresses a maximum threshold value. In response, the HMB component 230 can program additional memory management data on the HMB instead of the local memory 119.

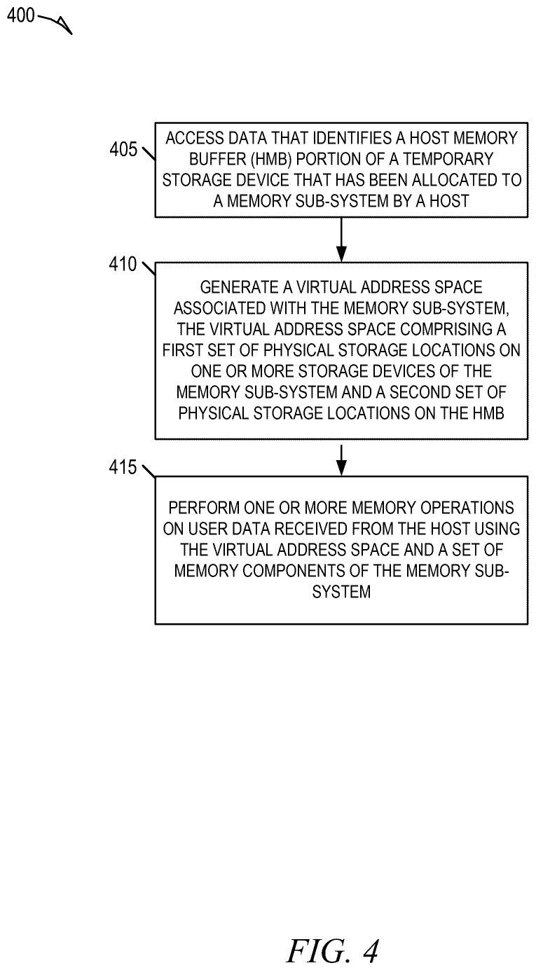

FIG. 4 is a flow diagram of an example method 400, in accordance with some implementations of the present disclosure. The method 400 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some examples, the method 400 is performed by the media operations manager 122 of FIG. 1. Although the processes are shown in a particular sequence or order, unless otherwise specified, the order of the processes can be modified. Thus, the illustrated examples should be understood only as examples, and the illustrated processes can be performed in a different order, and some processes can be performed in parallel. Additionally, one or more processes can be omitted in various examples. Thus, not all processes are required in every example. Other process flows are possible.

Referring now to FIG. 4, the method (or process) 400 begins at operation 405, with a media operations manager 122 of a memory sub-system (e.g., memory sub-system 110) accessing data that identifies a HMB portion of a temporary storage device that has been allocated to a memory sub-system by a host. Then, at operation 410, the media operations manager 122 generates a virtual address space associated with the memory sub-system, the virtual address space comprising a first set of physical storage locations on one or more storage devices of the memory sub-system and a second set of physical storage locations on the HMB. At operation 415, the media operations manager 122 performs one or more memory operations on user data received from the host using the virtual address space and a set of memory components of the memory sub-system.

In view of the disclosure above, various examples are set forth below. It should be noted that one or more features of an example, taken in isolation or combination, should be considered within the disclosure of this application.

Example 1: A memory sub-system comprising: a set of memory components; one or more storage devices; and at least one processing device operatively coupled to the set of memory components and the one or more storage devices, the at least one processing device configured to perform operations comprising: accessing data that identifies a HMB portion of a temporary storage device that has been allocated to the memory sub-system by a host; generating a virtual address space associated with the memory sub-system, the virtual address space comprising a first set of physical storage locations on the one or more storage devices and a second set of physical storage locations on the HMB; and performing one or more memory operations on user data received from the host using the virtual address space and the set of memory components.

Example 2. The memory sub-system of Example 1, wherein the one or more storage devices comprise at least one of static random access memory (SRAM) device or a first dynamic random access memory (DRAM) device, and wherein the set of memory components comprises non-volatile memory devices.

Example 3. The memory sub-system of Example 2, wherein the temporary storage device comprises a second DRAM device, and wherein the non-volatile memory devices comprise NAND storage devices.

Example 4. The memory sub-system of any one of Examples 1-3, the operations comprising storing the user data received from the host on the HMB.

Example 5. The memory sub-system of any one of Examples 1-4, the operations comprising: receiving, from the host, a request to program the user data; storing, on a first portion of the first set of physical storage locations, a mapping between a set of logical addresses associated with the request and a set of physical addresses on the set of memory components; and caching, on a second portion of the first set of physical storage locations, the user data prior to programming the user data to the set of physical addresses on the set of memory components.

Example 6. The memory sub-system of Example 5, the operations comprising: caching, on a portion of the second set of physical storage locations on the HMB, the user data that is also cached on the second portion of the first set of physical storage locations.

Example 7. The memory sub-system of Example 6, the operations comprising: transmitting, by the at least one processing device, an instruction to the temporary storage device to store the user data on the second set of physical storage locations on the HMB.

Example 8. The memory sub-system of any one of Examples 6-7, the operations comprising: deleting the user data from the second portion of the first set of physical storage locations after programming the user data to the set of physical addresses on the set of memory components; and maintaining storage of the user data on the second set of physical storage locations on the HMB after programming the user data to the set of physical addresses on the set of memory components.

Example 9. The memory sub-system of any one of Examples 6-8, the operations comprising: receiving a read request from the host associated with the set of logical addresses; determining that the set of logical addresses corresponds to the user data that has been cached on the portion of the second set of physical storage locations on the HMB; and retrieving the user data from the portion of the second set of physical storage locations on the HMB in response to receiving the read request from the host.

Example 10. The memory sub-system of Example 9, the operations comprising: transmitting, to the host, the user data that has been retrieved by the at least one processing device from the portion of the second set of physical storage locations on the HMB.

Example 11. The memory sub-system of any one of Examples 1-10, the operations comprising: receiving, from the host, a request to read the user data from a set of logical addresses; searching, the first set of physical storage locations, to identify a set of physical addresses on the set of memory components mapped to the set of logical addresses; retrieving, from the set of memory components, the user data stored in the set of physical addresses; and caching, on a portion of the second set of physical storage locations on the HMB, the user data that has been retrieved from the set of memory components.

Example 12. The memory sub-system of Example 11, the operations comprising: receiving, from the host, an additional request to read the user data from the set of logical addresses; determining that the set of logical addresses corresponds to the user data that has been cached on the portion of the second set of physical storage locations on the HMB; and retrieving the user data from the portion of the second set of physical storage locations on the HMB in response to receiving the additional read request from the host instead of retrieving the user data from the set of memory components.

Example 13. The memory sub-system of any one of Examples 1-12, the operations comprising: predicting a set of physical addresses on the set of memory components that is likely to be read by the host; retrieving, from the set of memory components, a set of user data stored in the set of physical addresses; and caching, on a portion of the second set of physical storage locations on the HMB, the set of user data that has been retrieved from the set of physical addresses that is predicted to be read by the host.

Example 14. The memory sub-system of any one of Examples 1-13, the operations comprising: prioritizing storage of a logical to physical address mapping on the first set of physical storage locations on one or more storage devices of the memory sub-system.

Example 15. The memory sub-system of Example 14, the operations comprising: determining that the one or more storage devices of the memory sub-system are full.

Example 16. The memory sub-system of Example 15, the operations comprising: in response to determining that the one or more storage devices of the memory sub-system are full, programming additional memory management data on the second set of physical storage locations on the HMB.

Methods and computer-readable storage medium with instructions for performing any one of the above Examples.

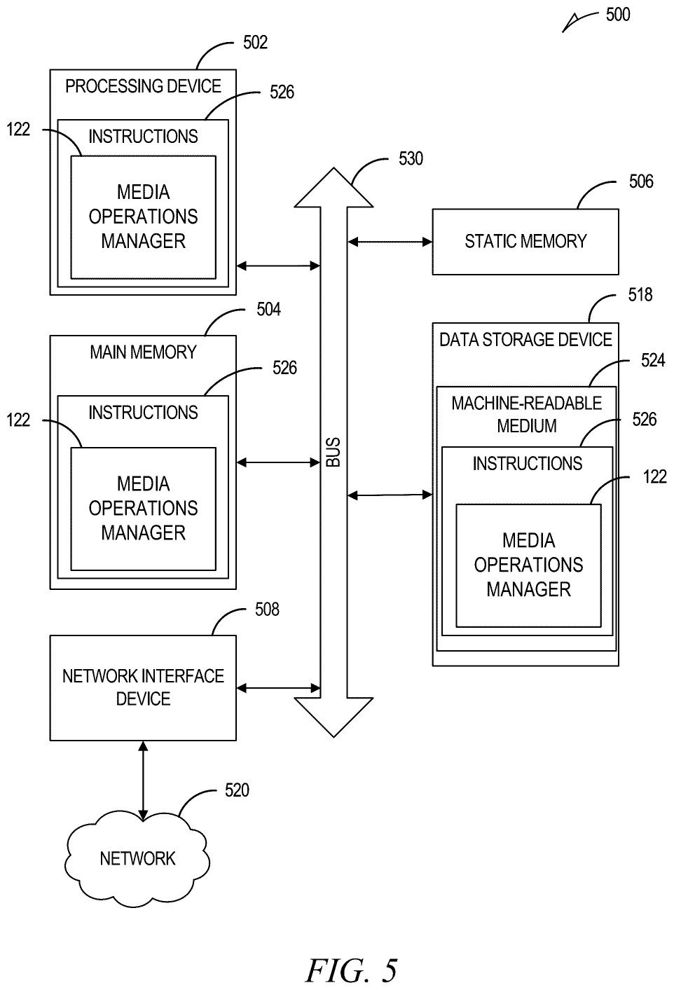

FIG. 5 illustrates an example machine in the form of a computer system 500 within which a set of instructions can be executed for causing the machine to perform any one or more of the methodologies discussed herein. In some examples, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the media operations manager 122 of FIG. 1). In alternative examples, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a network switch, a network bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

The processing device 502 represents one or more general-purpose processing devices such as a microprocessor, a central processing unit, or the like. More particularly, the processing device 502 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 502 can also be one or more special-purpose processing devices such as an application specific integrated circuit (ASIC), a field programmable gate array (FPGA), a digital signal processor (DSP), a network processor, or the like. The processing device 502 is configured to execute instructions 526 for performing the operations and steps discussed herein. The computer system 500 can further include a network interface device 508 to communicate over a network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one example, the instructions 526 implement functionality corresponding to the media operations manager 122 of FIG. 1. While the machine-readable storage medium 524 is shown in an example to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system's memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks; read-only memories (ROMs); random access memories (RAMs); erasable programmable read-only memories (EPROMs); EEPROMs; magnetic or optical cards; or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description above. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some examples, a machine-readable (e.g., computer-readable) medium includes a machine-readable (e.g., computer-readable) storage medium such as a read-only memory (ROM), random access memory (RAM), magnetic disk storage media, optical storage media, flash memory components, and so forth.

In the foregoing specification, the disclosure has been described with reference to specific examples thereof. It will be evident that various modifications can be made thereto without departing from the broader scope of the disclosure as set forth in the following claims. The specification and drawings are, accordingly, to be regarded in an illustrative sense rather than a restrictive sense.

What is claimed is:

1. A memory sub-system comprising:
a set of memory components;
one or more storage devices; and
at least one processing device operatively coupled to the set of memory components and the one or more storage devices, the at least one processing device configured to perform operations comprising:
accessing data that identifies a host memory buffer (HMB) portion of a temporary storage device that has been allocated to the memory sub-system by a host;
generating a virtual address space associated with the memory sub-system, the virtual address space comprising a first set of physical storage locations on the one or more storage devices and a second set of physical storage locations on the HMB; and
performing one or more memory operations on user data received from the host using the virtual address space and the set of memory components.

2. The memory sub-system of claim 1, wherein the one or more storage devices comprise at least one static random access memory (SRAM) device or a first dynamic random access memory (DRAM) device, and wherein the set of memory components comprises non-volatile memory devices.

3. The memory sub-system of claim 2, wherein the temporary storage device comprises a second DRAM device, and wherein the non-volatile memory devices comprise NAND storage devices.

4. The memory sub-system of claim 1, the operations comprising storing the user data received from the host on the HMB.

5. The memory sub-system of claim 1, the operations comprising:
receiving, from the host, a request to program the user data;
storing, on a first portion of the first set of physical storage locations, a mapping between a set of logical addresses associated with the request and a set of physical addresses on the set of memory components; and
caching, on a second portion of the first set of physical storage locations, the user data prior to programming the user data to the set of physical addresses on the set of memory components.

6. The memory sub-system of claim 5, the operations comprising:
caching, on a portion of the second set of physical storage locations on the HMB, the user data that is also cached on the second portion of the first set of physical storage locations.

7. The memory sub-system of claim 6, the operations comprising:
transmitting, by the at least one processing device, an instruction to the temporary storage device to store the user data on the second set of physical storage locations on the HMB.

8. The memory sub-system of claim 6, the operations comprising:
deleting the user data from the second portion of the first set of physical storage locations after programming the user data to the set of physical addresses on the set of memory components; and
maintaining storage of the user data on the second set of physical storage locations on the HMB after programming the user data to the set of physical addresses on the set of memory components.

9. The memory sub-system of claim 6, the operations comprising:
receiving a read request from the host associated with the set of logical addresses;
determining that the set of logical addresses corresponds to the user data that has been cached on the portion of the second set of physical storage locations on the HMB; and
retrieving the user data from the portion of the second set of physical storage locations on the HMB in response to receiving the read request from the host.

10. The memory sub-system of claim 9, the operations comprising:
transmitting, to the host, the user data that has been retrieved by the at least one processing device from the portion of the second set of physical storage locations on the HMB.

11. The memory sub-system of claim 1, the operations comprising:
receiving, from the host, a request to read the user data from a set of logical addresses;
searching, the first set of physical storage locations, to identify a set of physical addresses on the set of memory components mapped to the set of logical addresses;
retrieving, from the set of memory components, the user data stored in the set of physical addresses; and
caching, on a portion of the second set of physical storage locations on the HMB, the user data that has been retrieved from the set of memory components.

12. The memory sub-system of claim 11, the operations comprising:
receiving, from the host, an additional request to read the user data from the set of logical addresses;
determining that the set of logical addresses corresponds to the user data that has been cached on the portion of the second set of physical storage locations on the HMB; and
retrieving the user data from the portion of the second set of physical storage locations on the HMB in response to receiving the additional read request from the host instead of retrieving the user data from the set of memory components.

13. The memory sub-system of claim 1, the operations comprising:
predicting a set of physical addresses on the set of memory components that is likely to be read by the host;
retrieving, from the set of memory components, a set of user data stored in the set of physical addresses; and
caching, on a portion of the second set of physical storage locations on the HMB, the set of user data that has been retrieved from the set of physical addresses that is predicted to be read by the host.

14. The memory sub-system of claim 1, the operations comprising:
prioritizing storage of a logical to physical address mapping on the first set of physical storage locations on one or more storage devices of the memory sub-system.

15. The memory sub-system of claim 14, the operations comprising:
determining that the one or more storage devices of the memory sub-system are full.

16. The memory sub-system of claim 15, the operations comprising:
in response to determining that the one or more storage devices of the memory sub-system are full, programming additional memory management data on the second set of physical storage locations on the HMB.

17. A method comprising:
accessing data that identifies a host memory buffer (HMB) portion of a temporary storage device that has been allocated to a memory sub-system by a host;
generating a virtual address space associated with the memory sub-system, the virtual address space comprising a first set of physical storage locations on one or more storage devices of the memory sub-system and a second set of physical storage locations on the HMB; and
performing one or more memory operations on user data received from the host using the virtual address space and a set of memory components of the memory sub-system.

18. The method of claim 17, wherein the one or more storage devices comprise at least one of static random access memory (SRAM) device or a first dynamic random access memory (DRAM) device, and wherein the set of memory components comprises non-volatile memory devices.

19. The method of claim 18, wherein the temporary storage device comprises a second DRAM device, and wherein the non-volatile memory devices comprise NAND storage devices.

20. A non-transitory computer-readable storage medium comprising instructions that, when executed by at least one processing device, cause the at least one processing device to perform operations comprising:
accessing data that identifies a host memory buffer (HMB) portion of a temporary storage device that has been allocated to a memory sub-system by a host;
generating a virtual address space associated with the memory sub-system, the virtual address space comprising a first set of physical storage locations on one or more storage devices of the memory sub-system and a second set of physical storage locations on the HMB; and
performing one or more memory operations on user data received from the host using the virtual address space and a set of memory components of the memory sub-system.
